(19) United States
(12) Patent Application Publication
(10) Pub. No.: US 2026/0209536 A1
(43) Pub. Date: Jul. 23, 2026

(54) Ink Jet Ink Composition And Recording Method

(71) Applicant: SEIKO EPSON CORPORATION, Tokyo (JP)

(72) Inventors: Tetsuya AOYAMA, Shiojiri (JP); Kenta KIKUCHI, Suwa (JP); Masahiro YATAKE, Omura (JP)

(21) Appl. No.: 19/454,772

(22) Filed: Jan. 21, 2026

(30) Foreign Application Priority Data
Jan. 22, 2025 (JP) 2025-008826

(51) Int. Cl. C09D 11/324; C09D 11/023; C09D 11/033; C09D 11/037; C09D 11/107

(52) U.S. Cl. CPC C09D 11/324; C09D 11/023; C09D 11/033; C09D 11/037; C09D 11/107

(57) ABSTRACT

An ink jet ink composition includes: a pigment which is carbon black derived from a biological oil; a binder resin; and a solvent. The pigment is a self-dispersible pigment, the binder resin includes a self-emulsifying resin, and the solvent includes water. The ink jet ink composition is an aqueous ink.

The present application is based on, and claims priority from JP Application Serial Number 2025-008826, filed Jan. 22, 2025, the disclosure of which is hereby incorporated by reference herein in its entirety.

### BACKGROUND

### 1. Technical Field

The present disclosure relates to an ink jet ink composition and a recording method.

### 2. Related Art

An ink jet recording method can record a high-definition image with a relatively simple apparatus and has been rapidly developed in various fields. For example, JP-A-2023-128719 aims to provide an aqueous ink jet ink composition having excellent environmental friendliness and storage stability and discloses an ink jet ink composition that is an aqueous ink jet ink composition containing a color material derived from an organism, a dispersant derived from an organism, and an organic solvent derived from an organism, where the organic solvent includes a compound having a hydroxyl group, in which a solubility parameter based on the Hansen method is 24.0 (cal/cm³)^{1/2} or more.

It is desired to provide an aqueous ink jet ink containing a pigment, which is improved in clogging recoverability, color developability, transfer inhibition, and the like.

### SUMMARY

An ink jet ink composition according to an aspect of the present disclosure contains a pigment which is carbon black derived from a biological oil, a binder resin, and a solvent. The pigment is a self-dispersible pigment, the binder resin includes a self-emulsifying resin, and the solvent includes water. The ink jet ink composition is an aqueous ink.

A recording method according to an aspect of the present disclosure includes an attaching step of ejecting an ink using the above ink jet ink composition from an ink jet head to attach the ink to a recording medium.

### BRIEF DESCRIPTION OF THE DRAWINGS

FIG. 1 is a view showing an example of a recording apparatus used in a recording method of the present embodiment.

FIG. 2 is Table 1 showing the monomer compositions of self-emulsifying resins used in Examples.

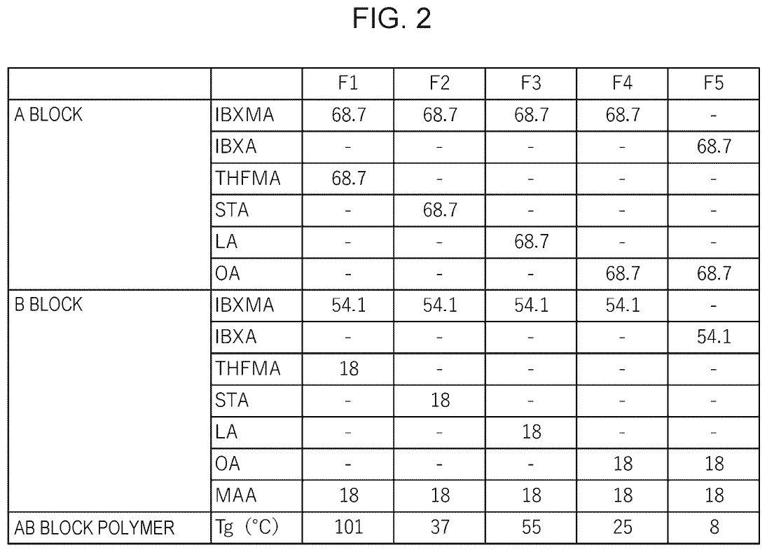

FIG. 3 is Table 2 showing the compositions of respective compositions used in Examples and the evaluation results thereof.

FIG. 4 is Table 3 showing the compositions of respective compositions used in Examples and the evaluation results thereof.

FIG. 5 is Table 4 showing the compositions of respective compositions used in Examples and the evaluation results thereof.

### DESCRIPTION OF EMBODIMENTS

The present embodiment will be described below in detail with reference to the drawings as needed, but the present disclosure is not limited thereto, and various modifications can be made without departing from the gist thereof. Note that in the drawings, the same elements are denoted by the same reference signs, and redundant description will be omitted. In addition, positional relationships such as up, down, left, and right are based on the positional relationships shown in the drawings unless otherwise specified. Furthermore, the dimensional ratios in the drawings are not limited to the ratios shown in the drawings.

### 1. Ink Jet Ink Composition

An ink jet ink composition according to the present embodiment contains a pigment which is carbon black derived from a biological oil, a binder resin, and a solvent, wherein the pigment is a self-dispersible pigment, the binder resin includes a self-emulsifying resin, and the solvent includes water, the ink jet ink composition being an aqueous ink.

Efforts have been made to reduce petroleum-derived components by using a coloring material derived from a natural product, such as carbon black derived from biological oil (hereinafter, also referred to as “biological oil CB”), in an ink to reduce the amount of CO₂ emissions due to petroleum-derived components, that is, efforts to use an environmentally friendly ink. “CB” means carbon black.

In a resin-dispersed pigment in which a pigment such as carbon black is dispersed using a dispersant resin, when adhesion or adsorption between the dispersant resin and the pigment is insufficient, there is a possibility that it is difficult to obtain dispersion stability. In addition, the dispersant resin may be liberated from the pigment during preservation, or the liberated dispersant resin may become a foreign substance. By using a self-dispersible pigment that does not require a dispersant resin, it is possible to prevent preservation stability from decreasing and the dispersant resin from becoming a foreign substance. However, in a case where the self-dispersible pigment is used, the abrasion resistance of the ink to the recording medium may be insufficient, and additionally the ink attached to the medium may be easily transferred to another medium.

Therefore, in the present embodiment, the self-emulsifying resin is used in combination in addition to the biological oil CB which is a self-dispersible pigment. Since the biological oil CB tends to have a higher content of oxygen atoms contained as an unburned component than petroleum-derived carbon black, more oxygen-containing functional groups are likely to be introduced by the surface treatment. Therefore, since the biological oil CB as a self-dispersible pigment has particularly high dispersion stability and high wettability of the pigment surface, the ink having particularly excellent storage stability, clogging recoverability, and bubble dischargeability is obtained. In addition, the reactivity with a metal salt such as a calcium salt contained in the recording medium is increased, and thus the ink having excellent color developability is obtained. Furthermore, the self-emulsifying resin has a large number of hydrophilic functional groups on the surface thereof, and has high affinity with the biological oil CB which is a self-dispersible pigment similarly having a large number of hydrophilic functional groups on the surface thereof. Therefore, the ink having excellent abrasion resistance and being difficult to transfer, that is, having excellent transfer resistance is obtained.

Components that can be contained in the ink composition according to the present embodiment and a method of producing the ink composition will be described below in detail.

### 1.1. Pigment

The ink composition in the present embodiment contains a pigment which is biological oil CB. By using the biological oil CB derived from a natural product, petroleum-derived components can be reduced, the amount of CO₂ emissions due to petroleum-derived components can be reduced, and an environmentally friendly ink can be obtained.

### Biological Oil CB

The pigment of the present embodiment contains biological oil CB. The biological oil CB is CB derived from a biological oil. The biological oil CB is obtained by carbonizing the biological oil into CB.

The biological oil is not an oil derived from underground resources such as petroleum, but is an oil derived from living organisms such as plants, animals, and microorganisms. Examples thereof include oils made from organisms and oils extracted or produced from organisms.

The biological oil is also referred to as biomass oil. The biological oil CB is also referred to as biomass oil-derived CB.

By using the carbon black derived from the biomass oil, components derived from petroleum contained in the ink can be reduced. As a result, the amount of carbon dioxide emission can be reduced as compared with the case where components derived from petroleum are used, and an environmentally friendly ink can be obtained.

The biological oil CB is carbon black obtained by carbonizing a biological oil, and has a manufacturing process similar to that of petroleum-derived carbon black in that a liquid is burned and carbonized, and is relatively easy to manufacture. Since impurities are also relatively easily reduced by refining the liquid raw material, it is possible to inhibit impurities from adhering to or remaining in the carbon black, and the preservation stability is further improved.

The method of producing the biological oil CB is not particularly limited, and for example, a known method such as a furnace method, a channel method, or a lamp method is used. Furthermore, in the process of preparing a raw material for a biological oil or a modified product thereof, the structural form and primary particles of carbon black can be controlled by, for example, adding an alkaline agent such as potassium hydroxide or sodium hydroxide, in addition to conditions such as heating temperature and sample amount.

Examples of the biological oil used as a raw material of the biological oil CB include an animal oil, a vegetable oil, and a microbial oil. Examples of the animal oil include, but are not limited to, a bovine oil, a horse oil, and a fish oil. Examples of the microbial oil include, but are not limited to, algal oils.

Among the biological oils CB, vegetable oil CB using a vegetable oil as a raw material is preferable in that a relatively homogeneous vegetable oil as a raw material is easily available in a relatively large amount, and that the vegetable oil as a raw material is easy to handle and easy to preserve.

The raw material of the vegetable oil CB is not particularly limited, and examples thereof include a vegetable seed oil, a tall oil, a wood tar, or a modified product such as a hydrogenated product of the vegetable seed oil, the tall oil, or the wood tar, or a derivative thereof. The modified products are products obtained by modifying vegetable oils as long as the effect of the present embodiment is obtained.

The primary particle size of the biological oil CB is preferably 80 nm or less. More preferably, the primary particle size is 5 to 70 nm, 15 to 55 nm, 20 to 45 nm, or 25 to 35 nm. When the primary particle size is within the above range, storage stability, transfer resistance, color developability, clogging recoverability, bubble dischargeability, and the like tend to be further improved.

The primary particle size of the carbon black can be determined as an arithmetic average size by observing carbon black particles with an electron microscope.

The primary particle is a particle of a carbon black minimum unit. In many cases, the primary particle is a particle of the minimum unit generated when a carbon black particle is formed by carbonization. A secondary particle is an aggregate formed by gathering and aggregating a plurality of primary particles. In the ink composition, carbon black is often dispersed in the form of secondary particles.

The DBP oil absorption amount of the biological oil CB is preferably 250 mL/100 g or less. Alternatively, the DBP oil absorption amount is 30 mL/100 g or more. More preferably, the DBP oil absorption amount is 50 to 200 mL/100 g, 80 to 170 mL/100 g, 80 to 150 mL/100 g, or 90 to 130 mL/100 g. When the DBP oil absorption amount is within the above range, storage stability, transfer resistance, color developability, clogging recoverability, bubble dischargeability, and the like tend to be further improved.

The DBP oil absorption amount is a value expressed as the amount of dibutyl phthalate (DBP) absorbed by carbon black in an amount of 100 g, and can be determined in accordance with the measurement method specified in JIS K6221. In general, the more developed the structural form of the secondary particle of carbon black, the larger the DBP oil absorption amount.

The content of the biological oil CB is preferably 0.1 to 15 mass %, 1 to 12 mass %, 2 to 9 mass %, or 3 to 7 mass % with respect to the total amount of the ink composition. When the content of the pigment is within the above range, the storage stability, the color developability, the clogging recoverability, and the bubble dischargeability tend to be further improved.

### 1.1.2. Self-Dispersible Pigment

Examples of the pigment include a resin-dispersed pigment which is dispersed by a resin, and a self-dispersible pigment which is dispersed by itself without a dispersant, depending on the dispersion form of the pigment.

The resin used for dispersing the resin-dispersed pigment also serves as a dispersant. In a resin-dispersed pigment which is dispersed using a resin as a dispersant, when adhesion or adsorption between the dispersant resin and the pigment is insufficient, it is difficult to obtain dispersion stability, and there is a possibility that the dispersant resin is liberated from the pigment during preservation, or the liberated dispersant resin becomes a foreign substance. In the ink composition according to the present embodiment, by using the self-dispersible pigment, it is possible to prevent preservation stability from decreasing and the dispersant resin from becoming a foreign substance. In addition, since the biological oil CB tends to have a higher content of oxygen atoms contained as an unburned component than carbon black derived from petroleum, a larger number of oxygen-containing functional groups are easily introduced by the surface treatment. In particular, the vegetable oil CB exhibits this tendency strongly.

Therefore, since the biological oil CB, in particular, the vegetable oil CB as a self-dispersible pigment has particularly high dispersion stability and high wettability of the pigment surface, the ink having excellent storage stability, clogging recoverability, and bubble dischargeability is obtained. In addition, since the reactivity with a metal salt such as a calcium salt contained in the recording medium is particularly high, the ink having excellent color developability is obtained.

The method of producing the self-dispersible pigment is not particularly limited, and examples thereof include a method of introducing a hydrophilic functional group to the pigment surface by performing a physical and/or chemical surface treatment. Examples of the physical treatment include a vacuum plasma treatment. Furthermore, examples of the chemical treatment include a treatment of oxidation with an oxidizing agent.

When the biological oil CB is used as the self-dispersible pigment, a hydrophilic functional group is easily introduced to the pigment by oxygen atoms contained in the biological oil CB, which is preferable. The introduced hydrophilic functional group is a hydrophilic functional group containing oxygen atoms because it is easily introduced to the pigment by the oxygen atoms contained in the biological oil CB. The introduction ratio of the hydrophilic functional group may be adjusted by adjusting the degree of the oxidation treatment.

Examples of the method of producing the self-dispersible pigment also include a method of introducing a hydrophilic functional group to the pigment surface by bonding a compound having a hydrophilic functional group to the pigment surface by a chemical reaction. Also in this case, the oxygen atoms contained in the pigment contribute to the chemical reaction with the compound having a hydrophilic functional group, and the hydrophilic functional group is easily introduced to the pigment, which is preferable.

The hydrophilic functional group introduced to the pigment by the above oxidation treatment may be reacted with the above compound having a hydrophilic functional group by a chemical reaction.

Examples of the hydrophilic functional group include an ionic group. Examples of the ionic group include an acidic group and a basic group. Such an ionic group is not particularly limited, and examples thereof include a carboxy group, an amino group, a sulfo group, and a phosphorus-containing acid group.

In particular, anionic groups such as a carboxy group, a sulfo group, and a phosphorus-containing acid group are preferable.

Examples of the hydrophilic functional group include a hydroxyl group. However, as the hydrophilic functional group for forming a self-dispersible pigment, the above-described hydrophilic functional group other than a hydroxyl group is preferable because the pigment is easily stably dispersed.

Among these, the self-dispersible pigment which is surface-treated by oxidation is preferable. By using such a self-dispersible pigment, the storage stability, the color developability, the clogging recoverability, and the bubble dischargeability tend to be further improved. Examples of the oxidation treatment include an oxidation treatment with hypohalous acid or a hypohalite, an oxidation treatment with ozone, and an oxidation treatment with persulfuric acid or a persulfate. Specific examples of the oxidizing agent include, but are not limited to, sodium hypochlorite.

In the biological oil CB, impurities contained due to the raw material are complicated, and the structure may also be complicated. Due to such impurities and the complexity of the structure, the preservation stability and the dispersion stability may tend to be relatively poor. The vegetable oil CB in particular has this tendency. Even in such a case, when a self-dispersible pigment is formed, a large number of hydrophilic functional groups are easily introduced, and excellent preservation stability and dispersion stability are easily obtained, which is preferable.

In addition, the vegetable oil CB is preferable since there are particularly a large number of oxygen atoms contained in the pigment, a hydrophilic functional group is easily introduced, and the effect of the disclosure of the present application is easily exhibited.

The term “structure” of the carbon black means the connection of particles and the size thereof, such as how the fine particles of carbon black are aggregated and what shape and arrangement the fine particles have. For example, the term means a state of secondary particles in which primary particles are aggregated.

### 1.2. Binder Resin

The ink composition in the present embodiment contains a self-emulsifying resin as the binder resin. Since the dissolution and dispersion of the self-emulsifying resin are reversible, the self-emulsifying resin does not become a foreign substance or cause clogging even when the ink is dried, and it is possible to improve the storage stability, clogging recoverability, and bubble dischargeability of the ink composition. In addition, the self-emulsifying resin has a large number of hydrophilic functional groups on the surface thereof, and has high affinity with the biological oil CB which is a self-dispersible pigment similarly having a large number of hydrophilic functional groups on the surface thereof. Therefore, the ink having excellent abrasion resistance and transfer resistance is obtained.

### 1.2.1. Self-Emulsifying Resin

The self-emulsifying resin has a high water concentration in the ink and is dispersed by self-emulsification. However, when water evaporates in a nozzle or the like and the concentration of the organic solvent increases, the self-emulsifying resin is dissolved. Then, when the concentration of water is increased again by the supply of a new ink, the ink can be self-emulsified again and redispersed.

The monomer constituting the self-emulsifying resin is not particularly limited, and for example, a hydrophobic monomer and a hydrophilic monomer can be used.

The hydrophobic monomer is not particularly limited, and examples thereof include alkyl (meth)acrylates such as methyl (meth)acrylate, ethyl (meth)acrylate, propyl (meth)acrylate, butyl (meth)acrylate, amyl (meth)acrylate, cyclohexyl (meth)acrylate, 2-ethylhexyl (meth)acrylate, octyl (meth)acrylate, decyl (meth)acrylate, lauryl (meth)acrylate, stearyl (meth)acrylate, isopropyl (meth)acrylate, isobutyl (meth)acrylate, tert-butyl (meth)acrylate, isoamyl (meth)acrylate, isooctyl (meth)acrylate, isodecyl (meth)acrylate, isododecyl (meth)acrylate, isobornyl (meth)acrylate, isostearyl (meth)acrylate, and dicyclopentanyl (meth)acrylate; and aromatic group-containing monomers such as styrene, xx-methylstyrene, 2-methylstyrene, vinyltoluene, divinylbenzene, chlorostyrene, phenyl (meth)acrylate, benzyl (meth)acrylate, and phenoxyethyl (meth)acrylate.

The hydrophilic monomer is not particularly limited, and examples thereof include unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrenesulfonic acid, 2-acrylamido-2-methylpropanesulfonic acid, and 3-sulfopropyl (meth)acrylate; unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate; ether-containing monomers such as cyclic trimethylolpropane formal (meth)acrylate, tetrahydrofurfuryl (meth)acrylate, and (2-methyl-2-ethyl-1,3-dioxolan-4-yl) methyl acrylate; unsaturated tertiary amine-containing monomers such as N,N-dimethylaminoethyl (meth)acrylate, N,N-dimethylaminopropyl (meth)acrylate, N,N-diethylaminoethyl (meth)acrylate, N,N-dimethylaminopropyl (meth)acrylamide, N,N-dimethylallylamine, vinylpyrrolidone, 2-vinylpyridine, 4-vinylpyridine, 2-methyl-6-vinylpyridine, and 5-ethyl-2-vinylpyridine; and ionic monomers such as unsaturated ammonium salt-containing monomers such as quaternized N,N-dimethylaminoethyl (meth)acrylate, quaternized N,N-diethylaminoethyl (meth)acrylate, and quaternized N,N-dimethylaminopropyl (meth)acrylate.

The self-emulsifying resin may be a homopolymer or a copolymer of the above hydrophilic monomer, hydrophobic monomer, or the like. The copolymer may be a random copolymer or a block copolymer, but the self-emulsifying resin in the present embodiment is preferably a block copolymer. In a case where the self-emulsifying resin is a block copolymer, the self-emulsifying resin can have a polymer micelle structure by differentiating the hydrophilicity of each block, and therefore, the solubility and the redispersibility can be further improved. Therefore, the storage stability, the clogging recoverability, and the bubble dischargeability of the ink composition tend to be further improved.

The block copolymer is not particularly limited. For example, the block copolymer may be a diblock copolymer, may be a triblock copolymer, or may have more blocks. Furthermore, the block may be constituted by a single monomer, or may be constituted by two or more kinds of monomers. In the block containing two or more kinds of monomers, the two or more kinds of monomers may be randomly arranged. In the block copolymer, the polymer chain constituting the polymer includes a plurality of blocks, and the blocks in the molecular chain are two or more kinds. The diblock copolymers consisting of two kinds of blocks are particularly preferred. In a case where the polymer chain consists of two kinds of blocks, the two kinds of blocks are also referred to as an A block and a B block. An AB block copolymer in which the molecular chain consists of one A block and one B block is preferable. In this case, the storage stability, clogging recoverability, and the like of the ink composition are more excellent, which is preferable.

Among these, the self-emulsifying resin is preferably an acrylic block copolymer. By using the acrylic block copolymer, there is a tendency that the storage stability, the clogging recoverability, and the bubble dischargeability can be further improved. The acrylic block copolymer is not particularly limited as long as it contains at least an acrylic monomer as a constituent component. The acrylic monomer is a monomer having a (meth)acryloyl group, such as (meth)acrylic acid, (meth)acrylate, or (meth)acrylamide.

The constituent ratio of the acrylic monomer to the constituent components of the acrylic block copolymer is preferably 50 mass % or more, more preferably 70 mass % or more, still more preferably 90 mass % or more, and particularly preferably 95 mass % or more. The constituent ratio is more preferably 98 mass % or more, and may be 100 mass %. Since there are many types of acrylic monomers, when the constituent ratio of the acrylic monomer is equal to or more than the above range, the degree of freedom in design is high. For example, the glass transition point, the acid value, and the like can be easily set in desired ranges, which is preferable.

The self-emulsifying resin binder is preferably a block copolymer consisting of an A block and a B block having a higher acid value than the A block. Examples of such an AB block copolymer include those having an A block having high hydrophobicity and a B block having higher hydrophilicity than the A block. As a result, the self-emulsifying resin binder tends to have a micelle structure in which the hydrophobic block is directed to the center and the hydrophilic block is directed to the outside. Accordingly, self-dispersion tends to be facilitated in an environment of a solvent containing a relatively large amount of water, such as in water. On the other hand, in an environment of a solvent containing a large amount of an organic solvent, the self-emulsifying resin binder does not form a micelle structure and is easily dissolved in the solvent. Thus, the form of the self-emulsifying resin binder is easily changed between dissolution and self-dispersion depending on the environment.

The self-emulsifying resin binder is preferably dissolved in a composition containing only an organic solvent having the same composition as the organic solvent contained in the ink.

Since the hydrophilic moiety is included as described above, in an environment of a solvent containing a relatively large amount of water, the redispersibility in water is further improved, and the clogging recoverability and the storage stability tend to be further improved. In addition, since the hydrophobic moiety is included, the solubility with respect to an organic solvent is excellent, and thus the solubility is further improved in an environment of a solvent having a large amount of an organic solvent, and the clogging recoverability and the redispersibility tend to be further improved.

In addition, since structures having high hydrophilicity are concentrated in the B block, the affinity with the biological oil CB having a large number of hydrophilic functional groups is high, the carbon black and the binder resin are firmly fixed, and it is possible to form a coating film of the ink having excellent abrasion resistance and transfer inhibition.

Note that the acid value in the present embodiment can be determined by calculation from the proportion of monomers having an acidic group among the monomers in the blocks.

The monomer constituting the B block may include a monomer having no acidic group, as needed, in addition to the monomer having an acidic group. Furthermore, the monomer constituting the A block may include the monomer having an acidic group within a range not exceeding the acid value of the B block, in addition to the monomer having no acidic group.

Examples of the monomer having an acidic group include, among the hydrophilic monomers described above, unsaturated carboxylic acid monomers such as acrylic acid, methacrylic acid, crotonic acid, itaconic acid, maleic acid, fumaric acid, citraconic acid, and 2-methacryloyloxymethylsuccinic acid; unsaturated sulfonic acid monomers such as styrene sulfonic acid, 2-acrylamido-2-methylpropanesulfonic acid, and 3-sulfopropyl (meth)acrylate; and unsaturated phosphoric acid monomers such as vinylphosphonic acid, vinyl phosphate, bis(methacryloxyethyl) phosphate, diphenyl-2-acryloyloxyethyl phosphate, and diphenyl-2-methacryloyloxyethyl phosphate.

The monomer having no acidic group is not particularly limited, and examples thereof include other monomers such as a hydrophobic monomer.

The content of the monomer having an acidic group in the B block is preferably 1 to 50 mass %, 5 to 40 mass %, 10 to 30 mass %, or 15 to 25 mass % with respect to the total amount of the monomers of the B block. When the content of the monomer having an acidic group in the B block is within the above range, the abrasion resistance, the clogging recoverability, and the redispersibility tend to be further improved.

In the present embodiment, the block polymer consisting of the A block and the B block having a higher acid value than the A block preferably has an A block polymer having two or more kinds of hydrophobic monomers and a B block copolymer having one or more kinds of hydrophobic monomers and one or more kinds of hydrophilic monomers. The hydrophobic monomers contained in the A block and the B block may be the same.

The glass transition point of the self-emulsifying resin binder is preferably 110° C. or less. Alternatively, the glass transition point is preferably 5° C. or more, and more preferably 10 to 100° C. Furthermore, the glass transition point is preferably 30° C. or more, more preferably 50° C. or more, and still more preferably 70° C. or more. Alternatively, the glass transition point is preferably 80° C. or less, more preferably 60° C. or less, still more preferably 50° C. or less, further more preferably 30° C. or less, and particularly preferably 20° C. or less. When the glass transition point is equal to or more than the above range, the storage stability, the bubble dischargeability, and the like are more excellent, which is preferable. When the glass transition point is equal to or less than the above range, the abrasion resistance, the clogging recoverability, and the like are more excellent, which is preferable.

The glass transition point is a glass transition point of the entire self-emulsifying resin binder, and in the case of the block copolymer, corresponds to a weighted average of each block. The glass transition point can be measured by a DSC method.

The method of obtaining the block copolymer is not particularly limited, and examples thereof include free radical polymerization and living radical polymerization. Among these, the living radical polymerization is preferably used in order to obtain a precise copolymer structure. The living radical polymerization is not particularly limited, and examples thereof include the NMP method, which uses nitroxide or the like, the ATRP method, which uses the oxidation-reduction of a metal complex, the RAFT method, which uses a dithiocarboxylic acid ester or the like, a method using a cobalt catalyst, the TERP method, which uses a tellurium compound, iodine transfer polymerization, which uses iodine, and the RTCP method, which uses an iodide as an initiator and an organic compound as a catalyst.

The initiator is not particularly limited as long as it is a known initiator used for radical polymerization, and examples thereof include azo compounds such as azobis(isobutyronitrile) and 2,2′-azobis(4-methoxy 2, 4-dimethylvaleronitrile); and peroxides such as benzoyl peroxide and dicumyl peroxide.

The content of the self-emulsifying resin is preferably 0.1 to 10 mass %, 0.5 to 5 mass %, or 1 to 3 mass with respect to the total amount of the ink composition. When the content of the binder resin is within the above range, the storage stability, the color developability, the transfer resistance, the abrasion resistance, and the bubble dischargeability tend to be further improved.

### 1.3. Solvent

The ink composition in the present embodiment contains a solvent. The solvent is a medium in which a pigment, a binder resin, and the like are dispersed or dissolved, and is a component of a liquid. The solvent contains at least water, and may contain an organic solvent or the like. When simply referred to as solvent, it means a solvent as a medium.

### 1.3.1 Organic Solvent

The ink composition in the present embodiment may contain an organic solvent as a solvent. The organic solvent preferably includes an organic solvent A having an octanol-water partition coefficient log P_{ow} value of 0 to 1. When the ink composition contains the organic solvent A, the binder resin is more easily dissolved in the ink when the drying of the ink progresses and the content of the organic component becomes predominant, and the storage stability and the clogging recoverability tend to be further improved. In addition, in the process of drying the ink on the recording medium, the binder resin and the vegetable oil CB which is a self-dispersible pigment are easily bonded to each other in the organic solvent A, and thus the abrasion resistance tends to be further improved. The ink composition in the present embodiment may include an organic solvent B having a log P_{ow} value other than 0 to 1, if necessary. The organic solvent B is an organic solvent other than the organic solvent A. The octanol-water partition coefficient log P_{ow} value is also referred to as octanol-water partition coefficient, log P_{ow} value, and the like.

The octanol-water partition coefficient log P_{ow} value of the organic solvent A is preferably 0.1 to 1, 0.2 to 0.9, 0.3 to 0.8, 0.4 to 0.7, or 0.5 to 0.6. When the log P_{ow} value is 0 or more, the solubility of the binder resin becomes higher, and when the log P_{ow} value is 1 or less, the compatibility with water tends to be more excellent. Therefore, when the log P_{ow} value is within the above range, the storage stability, the abrasion resistance, and the clogging recoverability of the ink composition tend to be further improved.

In the present embodiment, the octanol-water partition coefficient log P_{ow} value refers to a value defined by OECD Test Guideline 107. The octanol-water partition coefficient is expressed as log P_{ow}, log K_{ow}, and the like. A higher log P_{ow} value indicates higher hydrophobicity, and a lower log P_{ow} value indicates higher hydrophilicity.

The log P_{ow} value of a compound can be determined by various methods, and for example, it can be determined by measurement according to the measurement method specified in JIS Z 7260-117. The log P_{ow} value can also be calculated using Hansen Solubility Parameter Software (HSPiP).

The organic solvents A and B are not particularly limited, and examples thereof include monoalcohols, polyols, ethers, ketones, and amides. One kind of the organic solvent may be used alone, or two or more kinds thereof may be used in combination.

Examples of the monoalcohols include methanol, ethanol, n-propyl alcohol, isopropyl alcohol, n-butanol, 2-butanol, tert-butanol, isobutanol, n-pentanol, 2-pentanol, 3-pentanol, tert-pentanol, 2-phenoxyethanol, benzyl alcohol, and phenoxypropanol.

The polyols are organic solvents having two or more hydroxyl groups. Examples thereof include glycols having two hydroxyl groups and polyols having three or more hydroxyl groups. Examples of the polyols having three or more hydroxyl groups include glycerin.

Examples of the glycols include alkanediols and condensates having a structure in which hydroxyl groups between molecules of alkanediols are condensed. Alkanediols are alkanes substituted with two hydroxy groups. Examples of the condensate having a structure in which hydroxyl groups between molecules of alkanediols are condensed include a condensate having a structure in which hydroxyl groups between molecules of diols of alkanes having 2 to 4 carbon atoms are condensed.

The alkanediols preferably have 2 or more carbon atoms, more preferably 4 or more carbon atoms, and still more preferably 5 to 8 carbon atoms. Furthermore, 1,2-alkanediol is preferable.

Examples of glycols include alkanediols such as ethylene glycol, propylene glycol, 1,2-propanediol, 1,2-butanediol, 1,2-pentanediol, 1,2-hexanediol, 1,2-octanediol, 1,3-propanediol, 1,4-butanediol, and 1, 6-hexanediol; and condensates having a structure in which hydroxyl groups between molecules of alkanediols are condensed, the alkanediols including tetramethylene glycol, hexamethylene glycol, diethylene glycol, triethylene glycol, tetraethylene glycol, polyethylene glycol, dipropylene glycol, tripropylene glycol, polypropylene glycol, and (poly) tetramethylene glycol.

The ethers are not particularly limited, and examples thereof include alkyl ethers and glycol ethers. Examples of the alkyl ethers include dimethyl ether, methyl ethyl ether, diethyl ether, isopropyl methyl ether, and isopropyl ethyl ether.

Examples of the glycol ethers include alkylene glycol monoalkyl ethers such as ethylene glycol monomethyl ether, ethylene glycol monoethyl ether, ethylene glycol monoisopropyl ether, ethylene glycol monobutyl ether, diethylene glycol monomethyl ether, diethylene glycol monoethyl ether, diethylene glycol monobutyl ether, triethyleneglycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, propylene glycol monopropyl ether, propylene glycol monobutyl ether, dipropylene glycol monomethyl ether, dipropylene glycol monoethyl ether, dipropylene glycol monopropyl ether, dipropylene glycol monobutyl ether, tripropylene glycol monomethyl ether, and tripropylene glycol monobutyl ether; and alkylene glycol dialkyl ethers such as ethylene glycol dimethyl ether, ethylene glycol diethyl ether, ethylene glycol dibutyl ether, diethylene glycol dimethyl ether, diethylene glycol diethyl ether, diethylene glycol dibutyl ether, diethylene glycol methyl ethyl ether, diethylene glycol methyl butyl ether, triethylene glycol dimethyl ether, triethylene glycol diethyl ether, triethylene glycol dibutyl ether, triethylene glycol methyl butyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, dipropylene glycol diethyl ether, and tripropylene glycol dimethyl ether.

Examples of the ketones include acetone, methyl ethyl ketone, and diethyl ketone. Examples of the amides include lactam compounds and other amides. Examples of the lactam compound include 2-pyrrolidone, N-methyl-2-pyrrolidone, N-ethyl-2-pyrrolidone, and N-hydroxyethylpyrrolidone (HEP).

Among the organic solvents such as those described above, the organic solvent A has an octanol-water partition coefficient log P_{ow} value of 0 to 1. Examples of such organic solvents A include isopropyl methyl ether, diethylene glycol monobutyl ether, triethylene glycol monobutyl ether, 1,2-hexanediol methyl ethyl ketone, isopropyl alcohol, and methylethyl ketone.

The content of the organic solvent A is preferably 0.5 to 15 mass %, 3 to 12 mass %, 5 to 10 mass %, or 6 to 8 mass % with respect to the total amount of the ink composition. When the content of the organic solvent A is within the above range, the storage stability, the abrasion resistance, and the clogging recoverability tend to be further improved.

The organic solvents B may be the various organic solvents described above, but have an octanol-water partition coefficient log P_{ow} value of less than 0.

The content of the organic solvent B is preferably 0.5 to 20 mass %, 1 to 15 mass %, 3 to 11 mass %, 5 to 9 mass %, or 6 to 8 mass % with respect to the total amount of the ink composition. When the content of the organic solvent B is within the above range, the storage stability, the abrasion resistance, and the clogging recoverability tend to be further improved.

In a case where the organic solvents A and B are contained, the total content of the organic solvents is preferably 0.5 to 30 mass %, 10 to 20 mass %, 11 to 18 mass %, 12 to 17 mass %, or 13 to 15 mass % with respect to the total amount of the ink composition. When the content of the organic solvents is within the above range, the storage stability, the abrasion resistance, and the clogging recoverability tend to be further improved.

### 1.4. Moisturizer

The ink composition in the present embodiment may contain a moisturizer. Examples of the moisturizer include a liquid moisturizer and a solid moisturizer.

The liquid moisturizer is a compound which is liquid at normal temperature, and may be an organic solvent, but has particularly excellent moisturizing properties. Examples thereof include organic solvents having a normal boiling point of higher than 280° C., and particularly include organic solvents which are polyols having a normal boiling point of higher than 280° C. Examples of the organic solvent include glycerin. The normal temperature is 25° C.

The solid moisturizer is not particularly limited as long as it is solid at room temperature and has a moisturizing function while being solid at room temperature, and examples thereof include polyols such as mesoerythritol, trimethylolpropane, ditrimethylolpropane, pentaerythritol, and dipentaerythritol; glucose, mannose, fructose, ribose, xylose, arabinose, galactose, aldonic acid, glucitol (sorbit), maltose, cellobiose, lactose, sucrose, trehalose, maltotriose, and the like; sugars such as monosaccharides, disaccharides, oligosaccharides, and polysaccharides; derivatives of these sugars; and betaine such as trimethylglycine, triethylglycine, γ-butyrobetaine, homarine, trigonelline, carnitine, homoserine betaine, valine betaine, lysine betaine, ornithine betaine, alanine betaine, stachydrine, and betaine glutamate. One kind of the moisturizer may be used alone, or two or more kinds thereof may be used in combination.

Among these, the ink composition according to the present embodiment preferably contains betaine as the solid moisturizer. Betaine is a compound having a positive charge and a negative charge at non-adjacent positions in the same molecule, in which a hydrogen atom capable of dissociating is not bonded to the atom having the positive charge, possibly constituting an intramolecular salt, and the compound is not charged as a whole molecule. By containing betaine, it is possible to further inhibit misdirection and ejection failure of the ink jet ink composition due to drying of the ink composition in the nozzles of the ink jet head, and the clogging recoverability and the bubble dischargeability tend to be further improved.

The content of betaine is preferably 0.1 to 10 mass %, 2 to 8 mass %, 3 to 7 mass %, or 4 to 6 mass % with respect to the total amount of the ink composition. When the content of betaine is within the above range, the clogging recoverability and the bubble dischargeability tend to be further improved.

The content of the moisturizer is preferably 1 to 30 mass %, 10 to 20 mass %, or 13 to 17 mass % with respect to the total amount of the ink composition. When the content of the moisturizer is within the above range, the clogging recoverability and the bubble dischargeability tend to be further improved.

### 1.5. Surfactant

The ink composition according to the present embodiment may contain a surfactant. The surfactant is not particularly limited, and examples thereof include a silicone-based surfactant, an acetylene glycol-based surfactant, and a fluorine-based surfactant. One kind of the surfactants may be used alone, or two or more kinds thereof may be used in combination.

The acetylene glycol-based surfactants are not particularly limited, and examples thereof include 2, 4, 7,9-tetramethyl-5-decyne-4, 7-diol and alkylene oxide adducts of 2, 4, 7, 9-tetramethyl-5-decyne-4, 7-diol. Examples of commercially available products of the acetylene glycol-based surfactants include OLFINE E1010, EXP4200, and EXP4300; SURFYNOL SE, SURFYNOL 440, SURFYNOL 104, and SURFYNOL 465 (product names, manufactured by Nissin Chemical Industry Co., Ltd).

The fluorine-based surfactant is not particularly limited, and examples thereof include a perfluoroalkyl sulfonate, a perfluoroalkyl carboxylate, a perfluoroalkyl phosphonate, a perfluoroalkyl ethylene oxide adduct, a perfluoroalkyl betaine, and a perfluoroalkyl amine oxide compound.

The silicone-based surfactant is not particularly limited, and examples thereof include a polysiloxane-based compound and a polyether-modified organosiloxane. Examples of commercially available products of the silicone-based surfactants include BYK-306, BYK-307, BYK-333, BYK-341, BYK-345, BYK-346, BYK-348, BYK-UV3500, BYK-UV3510, BYK-UV3530, and BYK-UV3570 (product names, manufactured by BYK).

The content of the surfactant is preferably 0.1 to 4 mass %, 0.3 to 3 mass %, 0.5 to 2.5 mass %, or 1 to 2 mass % with respect to the total amount of the ink composition. When the content of the surfactant is within the above range, the storage stability, the clogging recoverability, and the bubble dischargeability tend to be further improved.

1.6. pH-Adjuster

The ink jet ink composition according to the present embodiment may contain a pH adjuster. The pH adjuster is not particularly limited, and examples thereof include inorganic acid such as sulfuric acid, hydrochloric acid, and nitric acid; inorganic bases such as lithium hydroxide, sodium hydroxide, potassium hydroxide, and ammonia; organic acids such as adipic acid, citric acid, and succinic acid; and organic bases such as triethanolamine, diethanolamine, monoethanolamine, triisopropanolamine, diisopropanolamine, and trishydroxymethylaminomethane. One kind of the pH adjuster may be used alone, or two or more kinds thereof may be used in combination.

The content of the pH adjuster is preferably 0.1 to 3 mass %, 0.3 to 2 mass %, or 0.5 to 1.5 mass % with respect to the total amount of the ink composition. When the content of the pH adjuster is within the above range, the storage stability, the abrasion resistance, the clogging recoverability, and the bubble dischargeability tend to be further improved.

### 1.7. Fulvic Acid

The ink composition in the present embodiment preferably contains fulvic acid. It is considered that the fulvic acid can function as a dispersion aid for the carbon black and the binder resin, and tends to further improve the dispersibility and further improve the storage stability and the like of the ink composition.

In addition, since the carbon black is a self-dispersible pigment, the carbon black has a large number of hydrophilic functional groups. Therefore, the affinity with fulvic acid is improved, the fulvic acid easily adheres to the carbon black, and storage stability and the like are further improved, which is preferable.

In addition, carbon black derived from a biological oil may have reduced preservation stability due to a complicated constitution of impurities, a complicated and large structure, or the like, but the present disclosure is particularly useful because excellent storage stability and the like can be obtained by fulvic acid.

Among the biological oil CB, the vegetable oil CB is preferable because fulvic acid tends to be easily generated by the oxidation treatment.

It is considered that fulvic acid functions as a surface coating material in the vicinity of the surface of the carbon black, thus making it possible to inhibit the primary particles or the secondary particles of the carbon black from further aggregating and coarsening. In addition, it is considered that impurities can be inhibited from adhering to the carbon black. In addition, when the wettability of the surface of the carbon black is further improved, the fine bubbles are less likely to be accumulated in the voids of the carbon black, and printing nozzle misfiring or cleaning nozzle misfiring is prevented. Therefore, the bubble dischargeability of the ink composition tends to be further improved. Furthermore, by further improving the affinity between the carbon black and the binder resin, the transfer resistance and the abrasion resistance of the ink composition tend to be further improved. In the present embodiment, fulvic acid does not correspond to the resin dispersant.

Fulvic acid is a general term for a group of acid type substances that are not precipitated by an acid among substances contained in corrosive substances. Fulvic acid can be obtained by separation and purification from soil using an acid or an alkali, and is also available as a commercial product. Fulvic acid is also produced in the process of subjecting carbon black to an oxidation treatment as a self-dispersion treatment. Since fulvic acid thus obtained has high water solubility and low pH dependency, it can maintain water solubility in a wide pH range and is less likely to become a foreign substance even when the pH changes. That is, even when a change in the state of the ink composition occurs, it can function usefully as a dispersion aid.

In the present embodiment, the fulvic acid may be separately prepared and mixed to prepare the composition, or the fulvic acid separated from the treatment liquid produced as a by-product during the oxidation treatment of the carbon black may be concentrated or diluted before use. Carbon black containing fulvic acid produced in the process of the oxidation treatment may also be used. Among these, it is preferable to use carbon black which has been subjected to an oxidation treatment and contains fulvic acid, and to adjust the amount of fulvic acid to a predetermined range by separately adding fulvic acid.

Fulvic acid preferably has a peak at an emission wavelength (EM) of 380 to 600 nm and an excitation wavelength (EX) of 180 to 320 nm in an excitation-emission matrix analysis method. That is, fulvic acid preferably has a peak in the range of the excitation wavelength (EX) corresponding to the range of the emission wavelength (EM). Furthermore, in the excitation-emission matrix analysis method, fulvic acid preferably has a peak at an emission wavelength (EM) of 400 to 600 nm and an excitation wavelength (EX) of 200 to 300 nm. The fulvic acid having peaks of the emission wavelength and the excitation wavelength within the above ranges has a carbon skeleton similar to that of carbon black, and has high affinity with carbon black. Therefore, the storage stability, the transfer resistance, the abrasion resistance, the clogging recoverability, and the bubble dischargeability tend to be further improved.

The peak position of the emission wavelength of fulvic acid of the present embodiment in the excitation-emission matrix analysis method is preferably 400 to 550 nm, 400 to 500 nm, 420 to 480 nm, or 430 to 460 nm. When the emission wavelength of the fulvic acid is within the above range, the storage stability, the transfer resistance, the abrasion resistance, the clogging recoverability, and the bubble dischargeability tend to be further improved.

The peak position of the excitation wavelength of fulvic acid of the present embodiment in the excitation-emission matrix analysis method is preferably 200 to 320 nm, 200 to 300 nm, 220 to 280 nm, or 240 to 270 nm. When the excitation wavelength of the fulvic acid is within the above range, the storage stability, the transfer resistance, the abrasion resistance, the clogging recoverability, and the bubble dischargeability tend to be further improved.

The number of peaks with the emission wavelength and the excitation wavelength of fulvic acid in the excitation-emission matrix analysis method may each independently be one or more or 2 to 3. When the fulvic acid has a plurality of peaks, it is preferable that at least one peak satisfies the above wavelength region, and it is more preferable that all peaks satisfy the above wavelength region.

The mass ratio of the fulvic acid to the pigment is preferably 0.0001 to 0.7, 0.001 to 0.5, 0.002 to 0.1, 0.003 to 0.05, or 0.005 to 0.02. When the mass ratio of the fulvic acid to the pigment is within the above range, the storage stability, the transfer resistance, the abrasion resistance, the clogging recoverability, and the bubble dischargeability tend to be further improved.

The content of the fulvic acid is preferably 0.001 to 5 mass %, 0.01 to 1 mass %, 0.02 to 0.3 mass %, or 0.03 to 0.1 mass % with respect to the total amount of the ink composition. When the content of the fulvic acid is within the above range, the storage stability, the transfer resistance, the abrasion resistance, the clogging recoverability, and the air bubble dischargeability tend to be further improved.

### 1.8. Water

The ink jet ink composition of the present embodiment is an aqueous ink in which the solvent contains water. The aqueous ink jet ink composition is an ink jet ink composition containing at least water as a main solvent component of the ink.

The content of water is preferably 40 mass % or more with respect to the total amount of the ink jet ink composition. The content of water is more preferably 40 to 99 mass %, 45 to 85 mass %, 50 to 70 mass %, 55 to 65 mass %, or 57 to 63 mass %. When the content of water is within the above range, the storage stability, the clogging recoverability, and the bubble dischargeability tend to be further improved.

### 1.9. Other Components

The ink composition may contain components other than the above-described components. As the other components, various additives such as a dissolution aid, a viscosity modifier, an antioxidant, a preservative, a fungicide, and a corrosion inhibitor can be added as appropriate.

### 2. Recording Method

The recording method in the present embodiment includes an attaching step of ejecting, using a predetermined ink jet head, the ink jet ink composition from the ink jet head and attaching the ink jet ink composition to a recording medium.

### 3. Recording Apparatus

The recording apparatus in the present embodiment includes the ink composition described above and an ink jet head having a nozzle which ejects the ink composition described above onto a recording medium. More preferably, the recording apparatus further includes a supply flow path through which the ink composition flows and which is connected to the ink jet head, and a filter unit provided in the supply flow path of the ink jet head.

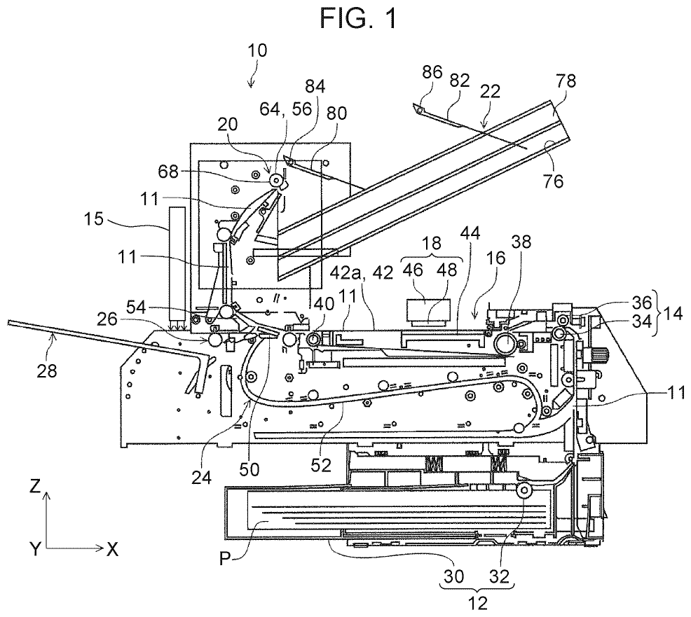

FIG. 1 shows an example of an ink jet recording apparatus that can be used in the present embodiment. The ink jet recording apparatus according to the present embodiment will be described in more detail with reference to FIG. 1. In an X-Y-Z coordinate system shown in FIG. 1, the X direction indicates the length direction of a recording medium, the Y direction indicates the width direction of the recording medium in a transport path in the recording apparatus, and the Z direction indicates the height direction of the apparatus.

A recording apparatus 10 is, as an example, a line-type ink jet printer capable of performing high-speed and high-density printing. The recording apparatus 10 includes a feeding section 12 storing a recording medium P such as paper, a transport section 14, a belt transport section 16, a recording section 8, a face-down (Fd) discharge section 20 as “discharge section”, a face-down (Fd) mounting section 22 as “mounting section”, a reversing path section 24 as “reversing transport mechanism”, a face-up (Fu) discharge section 26, and a face-up (Fu) mounting section 28.

The feeding section 12 is disposed at the lower portion of the apparatus in the recording apparatus 10. The feeding section 12 includes a feeding tray 30 storing the recording medium P and a feeding roller 32 feeding the recording medium P stored in the feeding tray 30 to a transport path 11.

The recording medium P stored in the feeding tray 30 is fed to the transport section 14 along the transport path 11 by the feeding roller 32. The transport section 14 includes a transport driving roller 34 and a transport driven roller 36. The transport driving roller 34 is rotationally driven by a drive source (not shown). In the transport section 14, the recording medium P is nipped between the transport driving roller 34 and the transport driven roller 36 and transported to the belt transport section 16 positioned downstream in the transport path 11.

The belt transport section 16 includes a first roller 38 positioned upstream in the transport path 11, a second roller 40 positioned downstream, an endless belt 42 mounted on the first roller 38 and the second roller 40 in a rotationally movable manner, and a support 44 supporting an upper section 42a of the endless belt 42 between the first roller 38 and the second roller 40.

The endless belt 42 is driven to move from the +X direction to the −X direction in the upper section 42a by the first roller 38 or the second roller 40 driven by a drive source (not shown). Therefore, the recording medium P transported from the transport section 14 is further transported downstream in the transport path 11 in the belt transport section 16.

The recording section 18 includes a line-type ink jet head 48 and a head holder 46 holding the ink jet head 48. The recording section 18 may be a serial type recording section, in which an ink jet head is provided on a carriage reciprocating in the Y-axis direction. The ink jet head 48 is disposed to face the upper section 42a of the endless belt 42 supported by the support 44. The ink jet head 48 ejects the ink toward the recording medium P in a case where the recording medium P is transported in the upper side section 42a of the endless belt 42, thereby executing recording. The recording medium P is transported by the belt transport section 16 downstream in the transport path 11 while the recording is carried out.

A first branch section 50 is provided downstream in the transport path 11 in the belt transport section 16. The first branch section 50 is configured to be switchable between the transport path 11 for transporting the recording medium P to the Fd discharge section 20 or the Fu discharge section 26, and a reversing path 52 of the reversing path section 24 for reversing the recording surface of the recording medium P and transporting again the recording medium P to the recording section 8. The recording surface of the recording medium P, which is switched to the reversing path 52 by the first branch section 50 and is transported, is reversed in a transport process in the reversing path 52, and the recording medium P is transported again to the recording section 8 such that the surface opposite to the initial recording surface faces the ink jet head 48.

Furthermore, a second branch section 54 is provided downstream of the first branch section 50 along the transport path 11. The second branch section 54 is configured to be capable of switching the transport direction of the recording medium P so as to transport the recording medium P toward the Fd discharge section 20 or transport the recording medium P toward the Fu discharge section 26.

The recording medium P transported toward the Fd discharge section 20 in the second branch section 54 is discharged from the Fd discharge section 20 and mounted on the Fd mounting section 22. At this time, the recording medium P is mounted such that the recording surface thereof faces the Fd mounting section 22. In addition, the recording medium P transported toward the Fu discharge section 26 in the second branch section 54 is discharged from the Fu discharge section 26 and mounted on the Fu mounting section 28. At this time, the recording medium P is mounted such that the recording surface thereof faces the side opposite to the Fu mounting section 28.

### 4. Recording Medium

The recording medium used in the present embodiment is not particularly limited, and examples thereof include an absorbent recording medium, a low-absorbent recording medium, and a non-absorbent recording medium, and the absorbent recording medium is preferable.

Examples of the absorbent recording medium include plain paper such as electrophotographic paper having high ink permeability, and ink jet dedicated paper including an ink absorbing layer formed of silica particles or alumina particles, or an ink absorbing layer formed of a hydrophilic polymer such as polyvinyl alcohol or polyvinyl pyrrolidone.

Examples of the low-absorbent recording medium include art paper, coated paper, and cast paper, which have relatively low ink permeability and are used for general offset printing.

Examples of the non-absorbent recording medium include films and plates of plastics such as polyvinyl chloride, polyethylene, polypropylene, polyethylene terephthalate (PET), polycarbonate, polystyrene, and polyurethane; plates of metals such as iron, silver, copper, and aluminum; metal plates and plastic films produced by evaporation of these various metals, and plates of alloys such as stainless steel and brass; and a recording medium in which a film of plastics such as polyvinyl chloride, polyethylene, polypropylene, polyethylene terephthalate (PET), polycarbonate, polystyrene, and polyurethane is bonded (applied) onto a paper base material.

### 5. Recorded Material

A recorded material of the present embodiment is obtained by attaching the ink composition described above to the recording medium. The recorded material of the present embodiment using the above-described ink composition can be recorded with an ink excellent in storage stability, color developability, transfer resistance, abrasion resistance, clogging recoverability, and bubble dischargeability.

### EXAMPLES

Hereinafter, the present disclosure will be described in more detail with reference to Examples and Comparative Examples. The present disclosure is not limited by the following Examples.

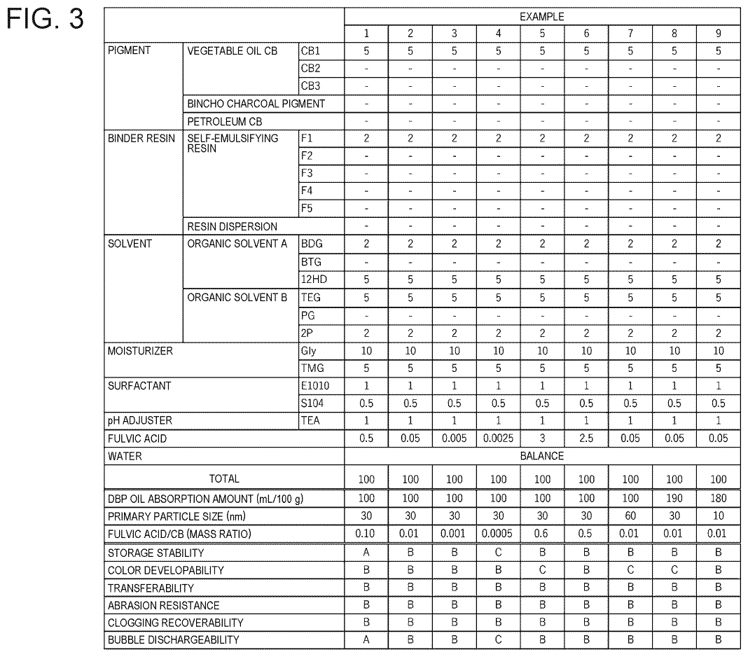

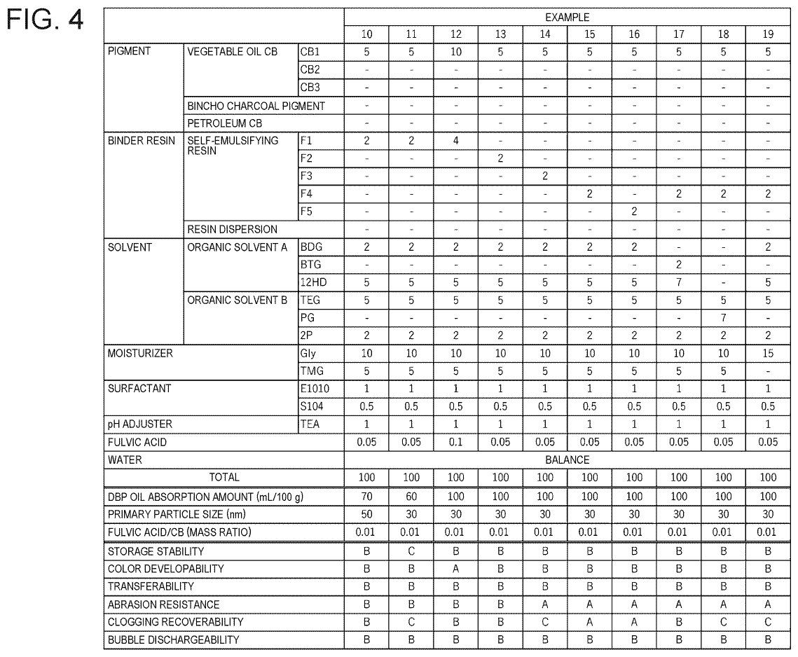

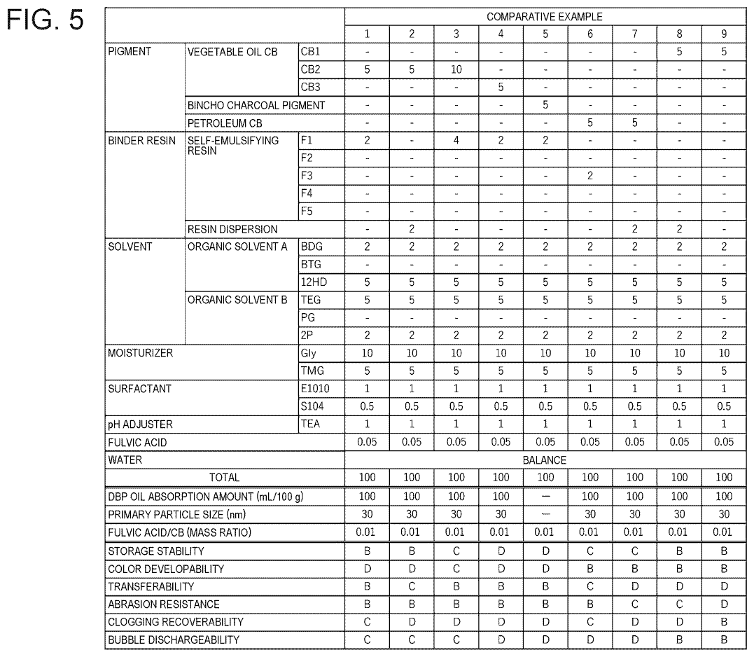

FIGS. 3 to 5 describe Tables 2 to 4 showing the compositions of the respective ink compositions of Examples and Comparative Examples and the evaluation results thereof.

### 1. Preparation of Ink Jet Ink Composition

Dispersion liquids are prepared by mixing and stirring so as to have the compositions described in Tables 2 to 4 to obtain the ink jet ink compositions of the respective examples. When fulvic acid was generated by the oxidation treatment of the carbon black, the fulvic acid content was adjusted so as to be the content described in Tables 2 to 4, including the amount of fulvic acid contained in the carbon black. The numerical value of each component shown in each example in Tables represents mass % unless otherwise specified. In addition, in Tables, each numerical value represents mass % of the solid content of each component (for solvents, the component amount of the solvent).

Details of the product components used in Tables 2 to 4 are as follows.

### Pigment:

CB1 to CB3, Bincho charcoal pigments, petroleum CB (see Preparation Example below)

### Binder Resin

F1 to 5, resin dispersion (see Preparation Example below)

### Fulvic Acid

Fulvic acid (see Preparation Example below)

### Organic Solvent

BDG (diethylene glycol monobutyl ether, log P_{ow} value: 0.56).
BTG (triethylene glycol monobutyl ether, log P_{ow} value: 0.44).
12HD (1,2-hexanediol, log P_{ow} value: 0.57)
TEG (triethylene glycol, log P_{ow} value: −1.75)
PG (propylene glycol, log P_{ow} value: −0.92)
2P (2-pyrrolidone, log P_{ow} value: −0.85)

### Moisturizer

Gly: glycerin
TMG: trimethylglycine

### Surfactant

E1010 (acetylene glycol-based surfactant, manufactured by Nissin Chemical Industry Co., Ltd.)
S104 (product name “SURFYNOL 104”, acetylene glycol-based surfactant, manufactured by Nissin Chemical Industry Co., Ltd.) pH Adjuster
TEA (triethanolamine)

### Water

Ion exchanged water

### 1.1. Adjustment of Pigments

### CB1 Preparation

### Washing Step

Carbon black (PRINTEX Nature, manufactured by Orion Engineered Carbons S.A., vegetable oil carbon black) in an amount of 25 g is stirred and washed with toluene to wash off substances such as unburned components adhering to the surface of the carbon black.

### Surface Treatment Step

To the carbon black after the washing step, 5 g of sodium hypochlorite is added in water, and the mixture is subjected to ultrasonic treatment to perform a surface treatment.

### Dispersion Step

The dispersion liquid of the carbon black after the surface treatment step is subjected to dispersion treatment for 1 hour with 0.3 mm beads using a rocking mill to obtain a slurry. Subsequently, 20 mass % of sodium hypochlorite is added to the carbon black in the slurry, and the mixture is heated to 70° C. and subjected to a surface treatment for 30 minutes. The particle size is measured, and when the particle size does not reach a target particle size, the dispersion treatment and the surface treatment are performed again. Since a new hydrophobic surface is formed on the carbon black by the dispersion, the surface treatment reaction is performed also in the dispersion step.

### Neutralization and Purification Step

Sodium hydroxide is added to the dispersion liquid of the carbon black after the dispersion step, and the dispersion liquid is neutralized to a pH of 8 to 9 suitable for an ink. After the neutralization reaction, the dispersion liquid is cooled to room temperature, solid-liquid separation is performed using a centrifugal separator or the like to perform desalination treatment. The solid is then recovered and dried at 100° C. Thus, CB1 which is a self-dispersible pigment is obtained.

### CB2 Preparation

Carbon black (PRINTEX Nature, manufactured by Orion Engineered Carbons S.A.) and JONCRYL 678 (styrene acrylic resin, manufactured by BASF) as a dispersant are mixed at a mass ratio of 2:1 to obtain CB2.

### CB3 Preparation

Carbon black (PRINTEX Nature, manufactured by Orion Engineered Carbons S.A.) and PEARLLEX NP (product name, sodium lignosulfonate, manufactured by Nippon Paper Industries Co., Ltd.) as a dispersant are mixed at a mass ratio of 2:3 to obtain CB3.

### Bincho Charcoal Pigment Preparation

Bincho charcoal (manufactured by Kiriya Chemical Co., Ltd., obtained by carbonizing wood, different from biological oil carbon black) is subjected to the same treatment as CB1 to obtain a Bincho charcoal pigment.

### Petroleum CB Preparation

Petroleum-derived carbon black (product name “Aqua-Black162”, manufactured by TOKAI CARBON CO., LTD.) is subjected to the same treatment as CB1 to obtain petroleum CB.

### Preparation Example of Fulvic Acid

Carbon black (PRINTEX Nature, manufactured by Orion Engineered Carbons S.A., vegetable oil carbon black) in an amount of 25 g is stirred and washed with toluene to wash off substances such as unburned components adhering to the surface of the carbon black. To the washed carbon black, 5 g of sodium hypochlorite is added in water, and the mixture is subjected to an oxidation treatment. After the treatment, the carbon black is removed by centrifugation, the waste liquid is recovered, an alkali aqueous solution is added to the waste liquid to separate the generated insoluble matter (humus) and the liquid from each other, an acid aqueous solution is further added to the liquid remaining after the removal of the insoluble matter, the generated insoluble matter is separated, and the remaining liquid is concentrated and purified to obtain fulvic acid.

### Excitation-Emission Matrix Analysis Method (EEM)

The measurement sample is diluted, and the excitation wavelength (Ex) is three dimensionally measured by a lateral reflection method under the following conditions. When the prepared measurement sample is dense, a surface reflection method can also be selected.
Holder: a holder for liquids (a lateral photometric system) or a holder for solids (a surface photometric system)
Cell: a surface-polished quartz cell (a 10×10 mm square quartz cell, lateral photometry) or a two-sided polished quartz cell (a 20×10 mm quartz cell, surface photometry)
Measurement wavelength for excitation (Ex): 200 to 700 nm
Measurement wavelength for emission (Em): 200 to 700 nm
Data interval for excitation (Ex): 5.0 nm
Data interval for emission (Em): 5.0 nm
Scan speed: 60,000 nm/min
Slit width for excitation (Ex): 5.0 nm
Slit width for emission (Em): 5.0 nm
Sensitivity: a photomultiplier voltage of 700 V
Response: 2 ms
Automatic filter control: ON (automatic high-order light cutting)

When the fulvic acid thus obtained is measured by the excitation-emission matrix analysis method, the fulvic acid has two peaks, i.e., a peak at an excitation wavelength of 260 nm and an emission wavelength of 445 nm and a peak at an excitation wavelength of 265 nm and an emission wavelength of 430 nm.

### 1.2. Binder Resin Preparation

Self-emulsifying resins F1 to F5 are obtained by the following procedure.

### F1 Preparation

236.3 parts by weight (pbw) of diethylene glycol monobutyl ether (BDG) and 2.3 pbw of 2-iodo-2-cyanopropane (CPI) as solvents, 3.7 pbw of 2,2-azobis(4-methoxy 2,4-dimethyl valeronitrile) (product name “V-70”, manufactured by FUJIFILM Wako Pure Chemical Corporation) (V-70) and 0.1 pbw of N-iodosuccinimide (NIS) as polymerization initiators, and 68.7 pbw of tetrahydrofurfuryl methacrylate (THEMA) and 68.7 pbw of isobornyl methacrylate (IBXMA) as monomers are charged into a reactor equipped with a stirrer, a thermometer, a reflux tube, and a nitrogen-introducing tube.

The raw materials charged into the reactor are stirred while bubbling nitrogen, and polymerized at 45° C. for 4 hours to synthesize a polymer (polymer block A). The solid content measured by sampling a part of the reaction solution is 37.4%, and the polymerization conversion rate calculated based on the solid content is almost 100%. The polystyrene-equivalent number average molecular weight (Mn) of the polymer block A measured by GPC using tetrahydrofuran (THE) as a developing solvent is 10,000, and the dispersity (PDI=weight average molecular weight (Mw)/number average molecular weight (Mn)) is 1.2. Hereinafter, the molecular weight is measured by this method. The glass transition point (Tg) of the polymer block A is 101.5° C., which is calculated from the Tg of the homopolymer of the monomer and the constituent blending ratio. The Tg of the homopolymer of THEMA is calculated to be 60° C., and the Tg of the homopolymer of IBXMA is calculated to be 155° C. Hereinafter, the Tg is obtained by this calculation method.

The obtained solution of the polymer block A is cooled to 40° C., and then, to a reactor, 2.7 pbw of V-70, 18.0 pbw of THEMA, 54.1 pbw of IBXMA, and 18.0 pbw of methacrylic acid (MAA) as monomers are added. The polymer block B is formed by polymerization at 40° C. for 4 hours to obtain an AB diblock copolymer. By measuring the solid content and the amount of residual monomers by gas chromatography, it is confirmed that the polymerization is almost completed. The solid content measured by sampling a part of the reaction solution is approximately 50%, and the polymerization conversion rate is approximately 100%. The number average molecular weight (Mn) of the obtained AB diblock copolymer is 17000, the PDI is 1.3, and the peak of GPC of the polymer block A is shifted to the high molecular weight side, thereby confirming that the AB diblock copolymer is obtained. That is, the number average molecular weight (Mn) of the polymer block B is 7000. In addition, the acid value of the polymer block B is calculated from the content of MAA in the above-described formulation, and is 130.3 mgKOH/g. The Tg of the polymer block B is 143.3° C. The Tg of the homopolymer of MAA is calculated as 228° C. A portion of the polymer solution is precipitated in methanol, filtered, washed well with methanol and dried to obtain a resinous solid. The resinous solid is titrated with 0.1 mol/L ethanolic potassium hydroxide solution and the acid value thereof is measured to be 51.5 mgKOH/g.

Then, a mixed liquid of 14.0 pbw of 28% ammonium water and 458.6 pbw of ion exchanged water is added under a room temperature condition for neutralization and emulsification to obtain a self-emulsifying resin F1. The amount of water to be added is adjusted so that the polymer content is 25%. The solid content of the F1 is 25.1%. The number average particle size of the emulsion particles measured using a dynamic light scattering particle size distribution measuring apparatus (granularity measuring instrument, product name “nanoSAQRA”, manufactured by Otsuka Electronics Co., Ltd.) after sufficiently diluting the F1 with water is 75 nm. The pH is 8.9. Furthermore, the viscosity is measured with an E-type viscosimeter and is 3.6 Pa·s at 25° C.

### F2 to F5 Preparation

The self-emulsifying resins F2 to F5 are obtained in the same manner as the self-emulsifying resin F1 except that the monomers to be used are changed to have the formulations shown in Table 1. The units are all parts by mass. In addition, the Tg of each self-emulsifying resin is summarized in Table 1. In all of F1 to F5, the polymer block B has a higher acid value than the polymer block A. All of F1 to F5 are dispersed in the ink by self-dispersion. All of F1 to F5 are dissolved in a composition of organic solvents containing only the organic solvents contained in the ink.
IBXMA (isobornyl methacrylate)
IBXA (isobornyl acrylate).
THEMA (tetrahydrofurfuryl methacrylate)
STA (stearyl acrylate)
LA (lauryl acrylate)
OA (octyl acrylate)
MAA (methacrylic acid)

### Resin Dispersion Preparation

A non-self-emulsifying resin dispersion is obtained as follows. Into a reactor equipped with a stirrer, a reflux condenser, a dropping device, and a thermometer, 900 g of ion exchanged water and 3 g of sodium lauryl sulfate were charged, and the mixture was heated to 70° C. while being stirred and replaced with nitrogen. While the internal temperature was maintained at 70° C., 4 g of potassium persulfate as a polymerization initiator was added and dissolved, and then an emulsion prepared in advance by adding 20 g of acrylamide, 300 g of styrene, 640 g of butyl acrylate, and 30 g of methacrylic acid to 450 g of ion exchanged water and 3 g of sodium lauryl sulfate with stirring was continuously added dropwise into the reaction solution over 4 hours. After the dropwise addition, the mixture was aged for 3 hours. After cooling the obtained aqueous emulsion to room temperature, ion exchanged water and 5% sodium hydroxide aqueous solution were added to adjust the solid content to 40 wt % and pH 8. The glass transition temperature of the resin particles in the obtained aqueous emulsion is −15° C.

### 2. Evaluation Method

### 2.1. Storage Stability

The ink composition is left to stand in an environment of 60° C. for 1 week. Thereafter, a change rate of the average particle size of the pigment particles in the ink after being left to stand to the average particle size of the pigment particles in the ink before being left to stand is calculated, and evaluated according to the following criteria. For measuring the average particle size, the volume average particle size D50 of the ink is measured by a dynamic light scattering method using ELSZ-1000 (manufactured by Otsuka Electronics Co., Ltd.).

### Evaluation Criteria

A: The change rate is less than ±5%.
B: The change rate is ±5% or more and less than ±10%.
C: The change rate is ±10% or more and less than ±20%.
D: The change rate is ±20% or more.

### 2.2. Color Developability (OD Value)

The ink composition is loaded into a modified machine of a printer PX-M791FT (product name, manufactured by Seiko Epson Corporation), and solid printing is performed on Xerox P paper (copy paper manufactured by Fuji Xerox Co., Ltd., basis weight: 64 g/m², paper thickness: 88 μm) with an A4 size at a print resolution of 720×720 dpi. The OD value of the recorded material is measured and evaluated according to the following evaluation criteria.

### Evaluation Criteria

A: OD value is 1.2 or more.
B: OD value is 1.0 or more and less than 1.2.
C: OD value is 0.8 or more and less than 1.0.
D: OD value is less than 0.8.

### 2.3. Transfer Resistance

Solid printing is performed on Xerox P paper (copy paper manufactured by Fuji Xerox Co., Ltd., basis weight: 64 g/m², paper thickness: 88 μm) at a temperature of 25° C. and a humidity of 50% at a printing Duty of 100% using a modified machine of a printer LX-10050 (product name, line ink jet printer, manufactured by Seiko Epson Corporation). The transfer marks formed at that time are evaluated according to the following evaluation criteria.

### Evaluation Criteria

A: The transfer mark is not seen when observed from a distance of 30 cm.
B: The transfer mark is seen when observed from a distance of 30 cm, but the transfer mark is not seen when observed from a distance of 50 cm.
C: The transfer mark is seen when observed from a distance of 50 cm, but the transfer mark is not seen when observed from a distance of 80 cm.
D: The transfer mark is seen when observed from a distance of 80 cm.

### 2.4. Abrasion Resistance

Each ink composition is filled in a modified machine of a printer PX-M791FT (manufactured by Seiko Epson Corporation), and 26 letters of the alphabet of 20 point size are recorded on Xerox P paper (copy paper manufactured by Fuji Xerox Co., Ltd., basis weight: 64 g/m², paper thickness: 88 μm). Immediately after the recording, the recording medium is fixed onto a horizontally installed flat surface, and 5 minutes after the recording, the letter portion is rubbed with a line marker “OPTEX CARE” (product name, manufactured by Zebra Co., Ltd.), and then the abrasion resistance is evaluated according to the following evaluation criteria based on the degree of bleeding of the ink.

### Evaluation Criteria

A: No color bleeding occurs even when rubbed three times.
B: No color bleeding occurs when rubbed twice, but color bleeding occurs when rubbed three times.
C: No color bleeding occurs when rubbed once, but color bleeding occurs when rubbed twice.
D: Color bleeding occurs when rubbed once.

### 2.5. Clogging Recoverability

A modified machine of a printer PX-M791FT (product name, manufactured by Seiko Epson Corporation) is filled with the ink, nozzle checking is performed to check that all the nozzles eject the ink, and then the printer is left to stand at 40° C. for 1 week with the head decapped. After being left to stand, the number of times of cleaning until all the nozzles are recovered is evaluated according to the following evaluation criteria.

### Evaluation Criteria

A: The number of times of cleaning is 1 or less.
B: The number of times of cleaning is 2 or more and 3 or less.
C: The number of times of cleaning is 4 or more and 5 or less.
D: After five times of cleaning, all nozzles are not recovered.

### 2.6. Bubble Dischargeability

Initial filling cleaning is performed on a modified machine of an unused new printer PX-M791FT (product name, manufactured by Seiko Epson Corporation) using each ink composition, and the number of times of cleaning until all the nozzles eject the ink composition is evaluated according to the following evaluation criteria. An ink composition having a good bubble dischargeability satisfies the initial filling property.

### Evaluation Criteria

A: All nozzles eject the ink composition only by the initial filling cleaning.
B: When only the initial filling cleaning is performed, nozzle misfiring occurs, and all nozzles eject the ink composition when the number of times of additional cleaning is 1 or less.
C: When only the initial filling cleaning is performed, nozzle misfiring occurs, and all nozzles eject the ink composition when the number of times of additional cleaning is 3 or less.
D: When only the initial filling cleaning is performed, nozzle misfiring occurs, and all nozzles do not eject the ink composition when the number of times of additional cleaning is 3 or less.

### 3. Evaluation Results

Tables 2 to 4 show that all of Examples which are the ink jet ink compositions of the present embodiment containing the pigment which is the biological oil-derived CB of the self-dispersible pigment and the binder resin which is the self-emulsifying resin are excellent in the color developability, the transfer inhibition, and the clogging recoverability. In addition, the storage stability, the abrasion resistance, and the bubble dischargeability also tend to be excellent.

On the other hand, in all of Comparative Examples which are not the ink jet ink composition of the present embodiment, any one of the color developability, the transfer inhibition, and the clogging recoverability is inferior.

What is claimed is:

1. An ink jet ink composition comprising:
a pigment which is carbon black derived from a biological oil;
a binder resin; and
a solvent, wherein
the pigment is a self-dispersible pigment,
the binder resin includes a self-emulsifying resin,
the solvent includes water, and
the ink jet ink composition is an aqueous ink.

2. The ink jet ink composition according to claim 1, wherein
a DBP oil absorption amount of the pigment is 70 to 180 mL/100 g, and
a primary particle size of the pigment is 10 to 50 nm.

3. The ink jet ink composition according to claim 1, wherein
the pigment is surface-treated by oxidation.

4. The ink jet ink composition according to claim 1, further comprising
fulvic acid.

5. The ink jet ink composition according to claim 4 wherein,
the fulvic acid has a peak at an emission wavelength (EM) of 400 nm to 600 nm and an excitation wavelength (EX) of 200 nm to 300 nm in an excitation-emission matrix analysis method.

6. The ink jet ink composition according to claim 1, wherein
the self-emulsifying resin is a block copolymer.

7. The ink jet ink composition according to claim 6, wherein
the self-emulsifying resin is a block copolymer made of an acrylic resin.

8. The ink jet ink composition according to claim 1, wherein
the solvent includes an organic solvent A having an octanol/water partition coefficient of 0 to 1.

9. The ink jet ink composition according to claim 1, further comprising
a moisturizer.

10. A recording method comprising
an ink attaching step of ejecting the ink jet ink composition according to claim 1 from an ink jet head to attach the ink jet ink composition to a recording medium.
